(19) United States
(12) Patent Application Publication
(10) Pub. No.: US 2026/0134419 A1
(43) Pub. Date: May 14, 2026

(54) FAST CROSS-DOMAIN TRANSACTION PROCESSING IN DISTRIBUTED COMPUTING SYSTEMS

(71) Applicant: CIRCLE INTERNET FINANCIAL, LLC, Boston, MA (US)

(72) Inventors: Walker MAYERCHAK, Cumberland, ME (US); Michael GRANT, Canton, MA (US); Chase Barrett MCDERMOTT, Houston, TX (US); Jonathan LIM, Salt Lake City, UT (US); Adrian SOGHOIAN, Brooklyn, NY (US); Keri Kaili WANG, Brooklyn, NY (US)

(21) Appl. No.: 18/946,690

(22) Filed: Nov. 13, 2024

(51) Int. Cl. G06Q 20/38; G06Q 20/36; H04L 9/00

(52) U.S. Cl. CPC G06Q 20/3825; G06Q 20/367; H04L 9/50

(57) ABSTRACT

Certain aspects of the present disclosure provide techniques for efficiently executing transactions across different processing domains in a distributed computing system. An example method generally includes receiving a request to transfer a quantity of tokens from a source processing domain to a target processing domain. Based on detecting initiation of a burn operation for the quantity of tokens on the source processing domain, the quantity of tokens are minted on the target processing domain. The minting is generally performed using resources in a cross-domain reserve resource pool. A request associated with the minting generally includes a signature generated by an issuer of the tokens and associated with the burn operation on the source processing domain. Execution of the request is finalized based on minting the quantity of tokens on the target processing domain.

### INTRODUCTION

Aspects of the present disclosure relate to cross-domain transaction processing in distributed computing systems.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

In some cases, transactions may be recorded on multiple blockchains that may not communicate with each other. For example, a transaction may be initially recorded on a first blockchain and then transferred, or “bridged”, to a second blockchain. Generally, the process of recording a transaction on a first blockchain and bridging the transaction to a second blockchain may be executed as a series of asynchronous, independent, transactions involving multiple parties. Because bridging a transaction from a first blockchain to a second blockchain generally involves multiple independent transactions, the processing cost of the overall bridging transaction and the risk of a transaction failure may be increased. For example, a transaction may be partially completed, leaving the system in an inconsistent state (e.g., where the first blockchain includes a record of a transaction, but the second blockchain does not include a corresponding record or only includes a partial record that does not complete the bridging process). Further, the use of multiple independent transactions may require coordination across different parties in order to complete the transaction and may impose significant processing overheads in generating and processing overhead messages within a blockchain system. Still further, the execution of some transactions may be premised on the completion of predecessor transactions, increasing the latency involved in completing transactions across different blockchains.

### BRIEF SUMMARY

Certain embodiments provide a computer-implemented method for efficiently executing transactions across different processing domains in a distributed computing system. An example method generally includes receiving a request to transfer a quantity of tokens from a source processing domain to a target processing domain. Based on detecting initiation of a burn operation for the quantity of tokens on the source processing domain, the quantity of tokens are minted on the target processing domain. The minting is generally performed using resources in a cross-domain reserve resource pool. A request associated with the minting generally includes a signature generated by an issuer of the tokens and associated with the burn operation on the source processing domain. Execution of the request is finalized based on minting the quantity of tokens on the target processing domain.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example distributed computing environment in which transactions across different domains are rapidly executed based on resources in a reserve resource pool, according to aspects of the present disclosure.

FIG. 2 depicts an example of messages exchanged between a bridging service and processing domains across which a transaction is to be rapidly executed based on resources in a reserve resource pool, according to aspects of the present disclosure.

FIG. 3 illustrates example operations for efficiently executing transactions across different domains in a distributed computing system based on resources in a reserve resource pool, according to aspects of the present disclosure.

FIG. 4 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. In these cryptocurrency systems, processed transactions may not be modified at a later date, thus providing an immutable ledger of the transactions performed using the cryptocurrency system.

In some cases, multiple blockchains (or processing domains) can be used to record a transaction. In one example, a base blockchain, also referred to as a “Layer 1” blockchain, may be a blockchain such as ETHEREUM®, and a blockchain that is “overlaid” on the Layer 1 blockchain, or otherwise configured to work alongside the Layer 1 blockchain, may be referred to as a “Layer 2” blockchain. An example of a Layer 2 blockchain may include the POLYGON® chain. Layer 1 blockchains generally provide a source of truth for a network and may generally be responsible for handling transactions on the Layer 1 blockchain and the Layer 2 blockchain(s) overlaid on the Layer 1 blockchain. Layer 2 blockchains generally allow for various applications to be built on top of a Layer 1 blockchain to extend the functionality of the Layer 1 blockchain, and to extend the functionality of the overall blockchain-based system. However, to maintain consistency between the Layer 1 blockchain and the Layer 2 blockchain(s), various transactions may be committed to both the Layer 1 blockchain and the Layer 2 blockchain(s). In another example, digital assets may be extant on a first blockchain and a second blockchain, each of which may be treated as equivalent blockchains (or processing domains) on which tokens can be minted and burned, subject to a global (e.g., cross-blockchain) constraint on the total extant number of tokens across different blockchains.

Generally, in a multi-blockchain (or multi-processing domain) environment, in order for a transaction to be executed across different blockchains, independent but related transactions may each need to be successfully executed, and in some aspects, the execution of an action on a first blockchain may be blocked until it is confirmed that a prerequisite action has completed execution on a second blockchain. For example, in bridging tokens from a source blockchain to a target blockchain, completion of a burn operation on a source blockchain, or at least receipt of attestation indicating that the operation has been performed on the source blockchain, may be a prerequisite for initiating a corresponding minting operation on the target blockchain. Details of the execution such cross-blockchain transactions may be found in U.S. patent application Ser. No. 18/127,588, assigned to the assignee hereof, the entire contents of which are hereby incorporated by reference. Because the speed at which transactions are performed on different blockchains may vary, the amount of time needed to finalize a transaction across blockchains may also vary and may cause significant delays in the availability of resources for users to perform transactions on these blockchains.

Aspects of the present disclosure provide techniques for efficiently performing bridged transactions across different processing domains in a distributed computing system. Generally, a cross-domain request broadcast to a first processing domain, such as a cross-chain token transfer request broadcast to a first blockchain, may be detected by a request handler that identifies that the cross-domain request is for a rapid execution of a cross-domain operation (e.g., a rapid transfer of digital assets, or tokens, from a source blockchain to a target blockchain). Based on detecting broadcast block confirmations associated with the cross-domain request broadcast to the first processing domain, a corresponding transaction associated with a second processing domain may be initiated. For example, in a cross-domain transfer operation in which tokens are transferred from a source blockchain to a destination blockchain, the broadcast block confirmations may include block confirmations associated with a token burn operation, and the corresponding transaction may be a token minting operation initiated on the second blockchain. The cross-domain request may be finalized and deemed completed when the second operation on the second processing domain is completed. By doing so, aspects of the present disclosure may provide for accelerated completion of cross-processing domain transactions in a distributed computing system, as transactions performed on the second processing domain may not strictly depend on completion of the corresponding transaction on the first processing domain, as the resources associated with the transaction may be sourced from a reserve resource pool without such resources being released from the first processing domain. Thus, resources may be made available on a destination processing significantly faster than would be made available using techniques in which finality of a first operation before execution of a corresponding second operation can commence, which may reduce transaction latencies and other delays that may occur from the lack of available resources to perform a transaction across processing domains in a distributed computing system.

### Example Fast Cross-domain Transactions in Distributed Computing Systems

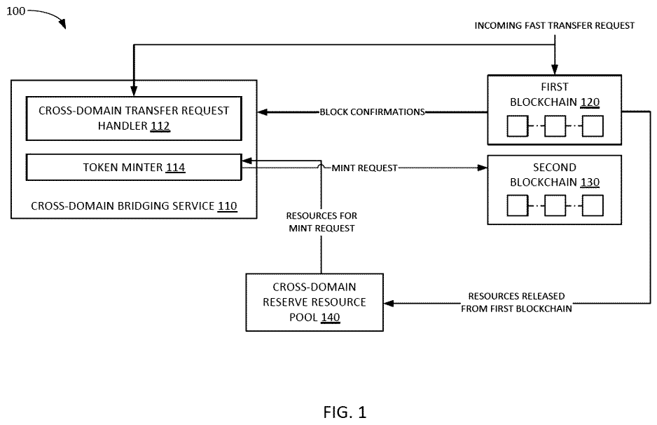

FIG. 1 illustrates an example computing environment 100 in which cross-chain transactions are executed based on resources in a reserve resource pool. As illustrated, computing environment 100 includes a cross-domain bridging service 110, a first blockchain 120, a second blockchain 130, and a cross-domain reserve resource pool 140.

To initiate a cross-chain transaction, a transfer request may be broadcast (e.g., by a user associated with a wallet from which assets are to be transferred from the first blockchain 120 to the second blockchain 130) to the first blockchain 120. The transfer request generally includes one or more parameters (e.g., in a header of the transfer request) indicating that the request is a request to perform a fast transfer of tokens from the first blockchain 120 to the second blockchain 130. For example, the one or more parameters may include a reserved value for a finality threshold defining when a cross-chain transaction is to be deemed completed. In some aspects, the transfer request may further include information defining other parameters for executing the cross-chain transaction, such as a maximum acceptable fee for performing the transaction, an expiration time for the transaction, and the like. Still further, in some aspects, the transfer request may include hook information defining additional actions to be performed as part of executing the transfer request. This hook information may include, for example, information identifying a function to be executed (e.g., a smart contract) as part of executing the transfer request, authentication information associated with the identified function, and the like. The transfer request broadcast to the first blockchain may initiate a burn operation on the first blockchain to burn a specified quantity of tokens in a wallet on the first blockchain 120 in preparation for minting the specified quantity of tokens in a wallet on the second blockchain 130, as the end result of executing the transfer request generally involves leaving the total extant quantity of the token across the first blockchain 120 and the second blockchain 130 static.

At the cross-domain bridging service 110, a cross-chain transfer request handler 112 can detect the broadcasting of the transfer request to the first blockchain 120 and initiate corresponding operations to complete the transfer of tokens or other digital assets from the first blockchain 120 to the second blockchain 130. Generally, the cross-chain transfer request handler 112 can examine the information carried in the transfer request to determine whether the transfer request is to be executed using a “slow” path or a “fast” path. A “slow” path generally involves waiting for tokens to be burned on the first blockchain 120, or at least for an attestation of such burn being completed on the first blockchain 120, before initiating a corresponding minting operation on the second blockchain 130. Meanwhile, a “fast” path generally allows for tokens to be minted on the second blockchain 130 based on resources in a cross-domain reserve resource pool 140 without waiting for completion or declared finality of the burn operation on the first blockchain 120. To determine whether the transfer request is to be executed using a “slow” path or a “fast” path, the cross-chain transfer request handler can examine the contents of the transfer request to determine whether the transfer request includes parameters indicating that the request is a request to perform a fast transfer of tokens from the first blockchain 120 to the second blockchain 130, such as a reserved value of for a finality threshold defining when a cross-chain transaction is to be deemed completed. If the transfer request does not include the reserved value for the finality threshold, then the cross-chain transfer request handler 112 can process the transfer request using the “slow” path. Otherwise, the cross-chain transfer request handler 112 can process the transfer request using the “fast” path.

In some aspects, the cross-chain transfer request handler 112 can further examine user information associated with the transfer request to determine whether a user associated with the transfer request is included on an allowlist of users that can perform a fast transfer of tokens across blockchains based on resources in the cross-domain reserve resource pool 140. If the user associated with the transfer request is not included on the allowlist, then the cross-chain transfer request handler 112 can process the transfer request using the “slow” path. Otherwise, the cross-chain transfer request handler 112 can process the transfer request using the “fast” path.

In some aspects, the cross-chain transfer request handler 112 can further examine other parameters included in the transfer request to determine whether to process the transfer request using the “slow” path or the “fast” path. For example, a maximum fee may be specified in the transfer request indicating an allowable amount of resources that can be used to satisfy the transfer request. If the current transaction cost (e.g., in terms of computing or other resources in excess of those to be transferred or otherwise used in a cross-domain transaction) on the first blockchain 120 and the second blockchain 130 to perform a transaction exceeds the specified maximum fee in the transfer request, the cross-chain request handler can process the transfer request using the “slow” path. In another example, the cross-chain transfer request handler 112 can determine whether sufficient resources exist in the cross-domain reserve resource pool 140 to process the transfer request using the “fast” path. Resource limits defined for a transfer request may be defined relative to the size of the cross-domain reserve resource pool 140 relative to a defined maximum size of a transfer request that can be processed using the “fast” path. In some aspects, the defined maximum size of a transfer request that can be processed using the “fast” path may be defined on a per-user basis, on a per-destination-blockchain basis, or the like. If the quantity of tokens specified in the transfer request complies with the resource limits defined for the transfer request, the cross-chain transfer request handler 112 can attempt to reserve resources in the cross-domain reserve resource pool 140 for processing the transfer request using the “fast” path. If the attempt to reserve resources in the cross-domain reserve resource pool 140 fails (or fails after a threshold number of attempts to reserve resources have been unsuccessfully performed), then the cross-chain transfer request handler 112 can proceed with processing the transfer request using the “slow” path. Otherwise, the cross-chain transfer request handler 112 proceeds with processing the transfer request using the “fast” path.

To execute the transfer request using the fast path, the cross-chain transfer request handler 112 can listen for block confirmations on the first blockchain. These block confirmations, which confirm the initiation of a burn operation on the first blockchain 120, may be tracked to determine when to initiate a corresponding mint request to mint tokens on the second blockchain. When a sufficient number of block confirmations generated by the first blockchain 120 (or systems associated with processing transactions on the first blockchain 120) have been identified, the cross-chain transfer request handler 112 can instruct the token minter 114 to mint the quantity of tokens on the second blockchain 130.

Generally, the token minter 114 is configured to execute token minting requests on the “fast” path using resources in a cross-domain reserve resource pool 140. In some aspects, the cross-domain reserve resource pool 140 may include resources in excess of those backing or otherwise associated with tokens on the first blockchain 120 and the second blockchain 130, which allows for tokens to be minted on the second blockchain 130 without waiting for the corresponding tokens to be burned on the first blockchain 120. Resources reserved by the cross-chain transfer request handler 112 can be used to allow for tokens to be minted on the second blockchain 130 with sufficient backing based on resources in the cross-domain reserve resource pool 140 such that at any time, a total extant amount of tokens across at least the first blockchain 120 and the second blockchain 130 is associated with off-chain resources according to a defined ratio. After the token minter 114 emits the mint request to the second blockchain 130, which may include a signature generated by an issuer of the tokens associated with the transfer request to allow for a minting operation on the second blockchain 130 to be correlated with a burn operation on the first blockchain 120, and after the mint request is processed and satisfied, the transfer request may be deemed to be completed. Generally, when handling the transfer request via the “fast” path, completion of the transfer request need not depend on completion and finalization of token burning operations on the first operation. When the token burn operation on the first blockchain is completed, however, resources associated with the tokens burned on the first blockchain may be returned to the cross-domain reserve resource pool 140. After completion of the burn operation on the first blockchain 120 and minting operation on the second blockchain 130, a total number of extant tokens across the first blockchain 120 and the second blockchain 130 may be unchanged (i.e., the total number of extant tokens across the first blockchain 120 and the second blockchain 130 prior to receipt of the transfer request at the first blockchain 120 may equal the total number of extant tokens across the first blockchain 120 and the second blockchain 130 after completion of the burn and minting operations on the first blockchain 120 and the second blockchain 130). While a total number of extant tokens across the first blockchain 120 and the second blockchain 130 may be increased by the quantity of tokens specified in the transfer request during execution of the transfer request using the “fast” path (e.g., between a time at which tokens are minted on the second blockchain 130 and burn operations are pending completion on the first blockchain 120), a relationship between the extant quantity of tokens and an associated resource may be maintained via the use of resources in the cross-domain reserve resource pool 140 to satisfy the minting request on the second blockchain 130.

In some aspects, the cross-chain transfer request handler 112 may invoke additional functions specified in the transfer request after transferring tokens from the first blockchain 120 to the second blockchain 130. For example, when the transfer request includes information specifying a function to be performed as part of handling the transfer request, the cross-chain transfer request handler 112 can examine the information to determine whether to execute the function or inform a user associated with the transfer request to manually invoke the function after the transfer request has been completed. For example, functions, which may be identified based on a smart contract and an operation to be performed within a specific smart contract, may be processed against functions in an allowlist to determine whether the cross-chain transfer request handler is permitted to invoke the function programmatically as part of executing the transfer request. If the function and/or smart contract is identified in the allowlist, then the cross-chain transfer request handler 112 can invoke the function based on the tokens minted and deposited into a specified wallet on the second blockchain 130.

In some aspects, execution of the token burn operation on the first blockchain 120, token minting operation on the second blockchain 130, and (optionally) a function identified in the transfer request may be performed as an atomic operation in which each of the token burn operation, the token minting operation, and execution of an identified function may need to be successfully executed in order for the transfer request to be deemed executed. If any of these operations fail, the first blockchain 120 and the second blockchain 130 may be returned to the state these blockchains were in prior to receipt of the transfer request, and the transfer request may be re-executed (e.g., if the transfer request has not timed out and is still valid) or may be dropped. In some aspects, the token burn operation may be separate from the token minting operation and any function executed as part of satisfying the transfer request. In such a case, the token minting operation and any function identified in the transfer request may be performed as an atomic operation, and the corresponding token burn operation on the first blockchain 120 may be handled separately such that failure of the token burn operation on the first blockchain 120 does not affect execution of the token minting operation on the second blockchain 130. In such a case, if the token burn operation on the first blockchain 120 fails, the token burn operation may be retried. As discussed, because the token minting operation on the second blockchain 130 may be performed based on resources in a cross-domain reserve resource pool 140, which includes resources in excess of those needed to back the total extant amount of tokens on the first blockchain 120 and the second blockchain 130, the relationship between extant tokens and associated resources may be maintained while tokens are pending completion of a burn operation on the first blockchain 120 and after minting of corresponding tokens on the second blockchain 130.

The first blockchain 120 and the second blockchain 130 may, in some aspects, be blockchains participating in a network for which the cross-domain bridging service 110 processes transactions, such as a cryptocurrency network. By way of example, the may be a network such as ALGORAND™, BITCOIN™, ETHEREUM®, SOLANA™, STELLAR™, and other cryptocurrency networks. Transactions on the first blockchain 120 and the second blockchain 130 may include, for example, the execution of one or more smart contracts on the first blockchain 120 and/or second blockchain 130 or by the generation of one or more blocks on the blockchain evidencing the occurrence of a transaction on the first blockchain 120 and/or second blockchain 130.

While FIG. 1 illustrates an example of cross-chain transaction processing, it should be recognized that the techniques described herein may be applicable to transaction processing across different processing domains generally. For example, the techniques described herein may be used in performing transactions across different networks, in performing transactions between an on-blockchain entity and an off-blockchain entity, or the like. A cross-domain transaction may, for example, include the execution of a first action in a first processing domain and a corresponding second action in a second processing domain. When executing a cross-domain transaction on a “fast” path, as discussed above, the corresponding second action executed in the second processing domain may be executed without waiting for execution of the first action to be completed.

### Example Messages Exchanged in Fast Cross-domain Transactions in Distributed Computing

Systems

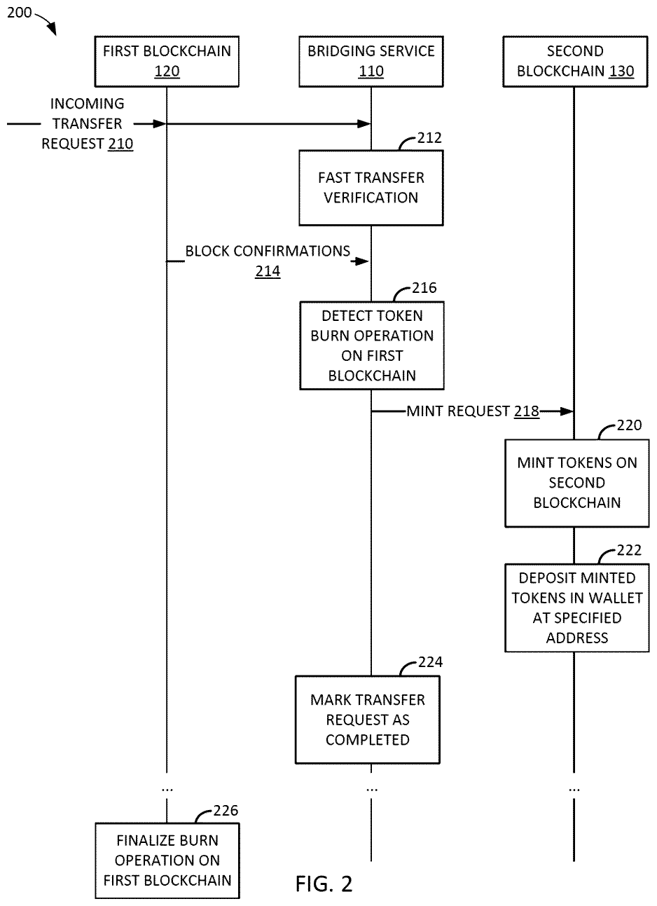

FIG. 2 depicts an example 200 of messages exchanged between a bridging service and processing domains across which a transaction is to be rapidly executed based on resources in a reserve resource pool, according to aspects of the present disclosure. While FIG. 2 illustrates an example of a cross-domain transaction in the context of transferring tokens from a first blockchain to a second blockchain, it should be understood that the example 200 may be applied to any type of cross-domain transaction for which fast execution based on resources in a reserve resource pool can be performed.

As illustrated, a transfer of tokens from a first blockchain 120 to a second blockchain 130 may be initiated by the broadcasting, by a user associated with a wallet on the first blockchain 120, of a transfer request 210 to the first blockchain 120. Because the transfer request 210 is broadcast to the first blockchain 120, the cross-domain bridging service 110 can monitor messaging on the first blockchain 120 to also determine that a transfer request has been broadcast to the first blockchain 120.

Generally, the transfer request 210 broadcast to the first blockchain specifies a quantity of a token to transfer to a destination wallet on the second blockchain 130. Because a total extant number of tokens across the first blockchain 120 and the second blockchain 130 should remain unchanged after bridging tokens from the first blockchain 120 to the second blockchain 130, a transfer request generally results in the execution of a token burn operation on the first blockchain 120 and a corresponding token minting operation on the second blockchain 130. Thus, receipt of the transfer request 210 may initiate a burn operation on the first blockchain 120.

In parallel with a burn operation performed on the first blockchain 120, the bridging service 110 verifies the transfer request as a fast transfer at block 212. As discussed above, to verify the transfer request as a fast transfer, the cross-domain bridging service 110 can determine whether a specified parameter in the transfer request 210 is set to a reserved value associated with a fast request. If the specified parameter in the transfer request 210 is set to the reserved value, the cross-domain bridging service 110 can determine that the transfer request 210 is a fast request and process the transfer request 210 using a “fast” path in which confirmation of a token burn operation on the first blockchain 120 is not a prerequisite for minting tokens on the second blockchain 130 out of a cross-domain reserve resource pool (e.g., the cross-domain reserve resource pool 140 illustrated in FIG. 1). In some aspects, the cross-domain bridging service 110 can perform additional checks, such as user identification checks, fast minting allowance checks, and the like, to further determine whether the transfer request 210 can be processed as a fast transfer on the “fast” path or whether to process the transfer request 210 using a “slow” path in which confirmation of a token burn operation on the first blockchain 120, or at least attestation of execution of the token burn operation on the first blockchain 120, is a prerequisite for performing the minting operations on the second blockchain 130.

To process the transfer request 210 using the “fast” path, the cross-domain bridging service 110 listens for block confirmations 214 broadcast by the first blockchain 120 indicating that a burn operation on the first blockchain 120 have been accepted by the first blockchain 120. At block 216, the bridging service detects a token burn operation on the first blockchain 120 based on the detection of a threshold number of block confirmations 214 indicating the acceptance of the burn operation by the first blockchain 120, the cross-domain bridging service 110. The threshold number of block confirmations 214 to be detected at block 216 to determine that a fast transfer can proceed may vary based on the blockchain from which tokens are to be bridged to the second blockchain 130. Generally, the number of block confirmations may be associated with a time period over which transactions on a blockchain can be invalidated, with blockchains having larger windows in which transactions can be invalidated being associated with higher threshold numbers of block confirmations to be detected prior to proceeding with a fast transfer of tokens from the first blockchain 120 to the second blockchain 130.

After the threshold number of block confirmations, and thus a burn operation, are detected on the first blockchain 120 at block 216, the cross-domain bridging service 110 can emit a mint request 218 to the second blockchain 130. The mint request 218 generally identifies a destination wallet into which tokens are to be minted. The mint request 218 may be minted based on a set of resources reserved for a minting transaction from a cross-domain reserve resource pool, which represents a set of resources in excess of those needed to back the total extant number of tokens on the first blockchain 120 and the second blockchain 130 (amongst other blockchains not illustrated in FIG. 1 or 2).

Based on receiving the mint request 218, at block 220, the quantity of tokens identified in the mint request 218 are minted on the second blockchain. At block 222, the minted tokens are deposited in a wallet at a specified address on the second blockchain. Generally, the address associated with the wallet into which the minted tokens are deposited may be specified in the mint request.

At block 224, based on detecting completion of the mint request 218, the bridging service 110 marks the transfer request 210 as completed. The marking of the transfer request 210 as completed may be performed while the burn operation is pending completion on the first blockchain 120. At a later point in time, at block 226, the burn operation is finalized on the first blockchain 120. After the burn operation is finalized on the first blockchain 120, the resources previously allocated to backing tokens on the first blockchain 120 may be released, and the resources in the cross-domain reserve resource pool may be replenished.

### Example Operations for Fast Cross-domain Transactions in Distributed Computing Systems

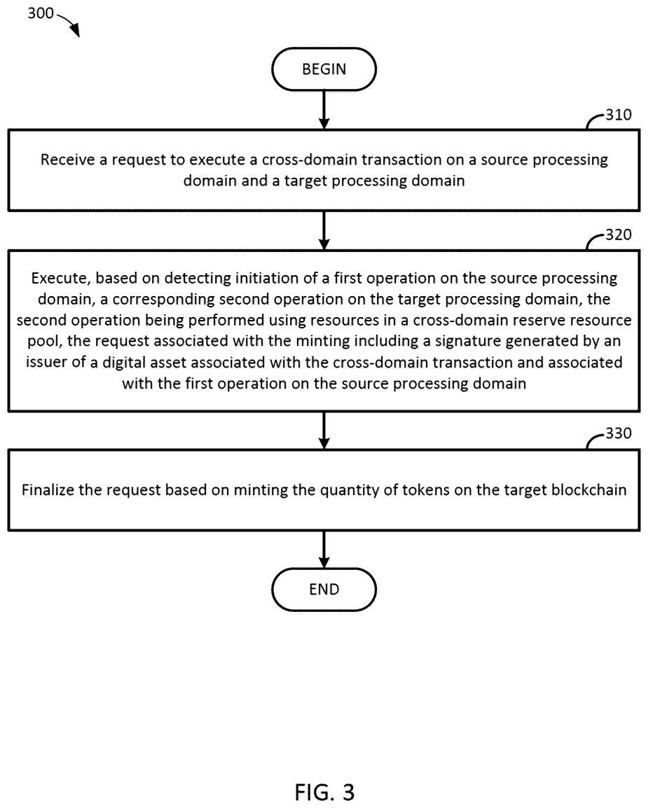

FIG. 3 illustrates example operations 300 for fast cross-domain transaction processing in distributed computing systems, according to aspects of the present disclosure. The operations 300 may be performed, for example, by a cross-domain bridging service, such as the cross-domain bridging service 110 illustrated in FIG. 1 or other computing system that can bridge tokens from a source blockchain to a destination blockchain.

As illustrated, the operations 300 begin at block 310, with receiving a request to execute a cross-domain transaction on a source blockchain (e.g., the first blockchain 120 illustrated in FIGS. 1 and 2) and a target blockchain (e.g., the second blockchain 130 illustrated in FIGS. 1 and 2).

In some aspects, the request comprises a bridging request between the source processing domain and the target processing domain including a reserved value for a finality threshold, the reserved value indicating that the request can be finalized without waiting for completion of the burn operation on the source blockchain. In some aspects, request may be received based on detecting a broadcast of the bridging request to the first blockchain.

At block 320, the operations 300 proceed with executing, based on detecting initiation of a first operation on the source processing domain, a corresponding second operation on the target blockchain. Generally, the second operation is performed using resources in a cross-blockchain reserve resource pool (e.g., the cross-domain reserve resource pool 140 illustrated in FIG. 1). A request associated with the second operation may include a signature generated by an issuer of a digital asset associated with the cross-domain transaction and associated with the first operation on the source processing domain.

In some aspects, execution of the second operation is based on detecting a threshold number of block confirmation messages associated with execution of the first operation on the source processing domain. The threshold number of block confirmation messages may be defined for the source processing domain based on the size of a window during which transactions on the source processing domain may be invalidated. Generally, smaller windows may allow for a smaller number of block confirmations to be detected prior to initiating the second operation on the second processing domain, while larger windows may result in a larger number of block conformations that are needed prior to initiating the second operation on the second processing domain.

In some aspects, the operations 300 further include failing to detect the threshold number of block confirmation messages within a threshold time period. The failure to detect the threshold number of block confirmation messages may be, for example, associated with a timeout window in which the threshold number of block confirmation messages are expected to be received. Execution of the second operation on the target processing domain may be initiated in response to detecting completion of the first operation on the source processing domain (e.g., using the “slow” execution path discussed above).

At block 330, the operations 300 proceed with finalizing execution of the request based on executing the second operation on the target processing domain. In some aspects, the request may be finalized without waiting for completion of the first operation on the source processing domain.

In some aspects, the request includes an identifier of a sender associated with the request. The operations 300 may further include allowing, based on the identifier of the sender being included on an allowlist, execution of the second operation on the target processing domain based on detecting initiation of the first operation.

In some aspects, the first operation comprises a token burn operation on a source blockchain and the second operation comprises a minting operation on a target blockchain, both of which may be constituents of a cross-chain transfer request. Execution of the minting operation may be based on a comparison of the quantity of tokens included in the request and an outstanding allowance for token minting from the cross-domain reserve resource pool. Generally, when the quantity of tokens included in the request is less than an outstanding allowance for token minting from the cross-domain reserve resource pool, the minting on the target blockchain may proceed while a burn operation is pending completion on the source blockchain. The outstanding allowance may be defined globally (e.g., across all transactions pending that involve the use of resources from the cross-domain reserve resource pool) and on a per-transaction basis. In some aspects, the per-transaction allowance may differ based, for example, on geographic location, user identity, account age, or other properties that may be defined for managing fast transfers (and bridging) of tokens from a source blockchain to a target blockchain.

In some aspects, an amount of resources associated with the cross-domain reserve resource pool is replenished after the request is finalized based on confirmation of the burn operation.

In some aspects, the request further includes information associated with one or more actions to execute as part of satisfying the request. This information may include, for example information identifying a smart contract to be invoked as part of satisfying the request and/or other metadata indicative of or otherwise associated with the one or more actions to be executed. The operations may further include executing the one or more actions prior to finalizing execution of the request. For example, a smart contract may be executed on the target blockchain based on the quantity of tokens being minted on the target blockchain. In some aspects, at least the minting and execution of the one or more actions are performed as an atomic operation.

### Example System for Fast Cross-domain Transactions in Distributed Computing Systems

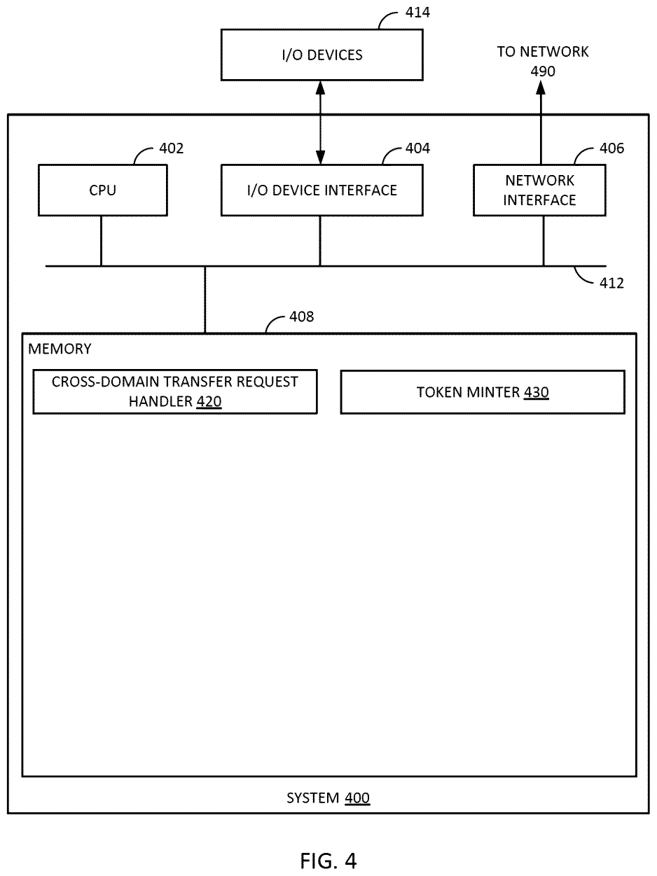

FIG. 4 illustrates an example system 400 configured to perform the methods described herein, including, for example, operations 300 illustrated in FIG. 3. In some embodiments, system 400 may act as a bridge (e.g., a cross-domain bridging service 110) between a first blockchain 120 and a second blockchain 130, as illustrated in FIG. 1.

As shown, system 400 includes a central processing unit (CPU) 402, network interface 406 through which system 400 is connected to network 490 (which may be a local network, an intranet, the internet, or any other group of computing devices communicatively connected to each other), a memory 408, and an interconnect 412. The network interface 406 may be used to receive requests to perform transactions on the blockchain and accompanying message payloads to include in records evidencing these transactions on the blockchain (e.g., as depicted and described with respect to FIGS. 1 through 3.

CPU 402 may retrieve and execute programming instructions stored in the memory 408. Similarly, the CPU 402 may retrieve and store application data residing in the memory 408. The interconnect 412 transmits programming instructions and application data, among the CPU 402, network interface 406, and memory 408.

CPU 402 is included to be representative of a single CPU, multiple CPUs, a single CPU having multiple processing cores, and the like.

Memory 408 is representative of a volatile memory, such as a random access memory, or a nonvolatile memory, such as nonvolatile random access memory, phase change random access memory, or the like. As shown, memory 408 includes a cross-domain transfer request handler 420 and an action executor 430.

The cross-domain transfer request handler 420 generally corresponds to the cross-chain transfer request handler 112 illustrated in FIG. 1. Generally, the cross-chain transfer request handler 420 listens for broadcasts of operations on the first blockchain. For example the operations may be transfer requests specifying a transfer of a quantity of tokens from a first blockchain to a second blockchain, requests to execute a cross-domain operation involving a first operation executed on a first processing domain and a corresponding second operation executed on a second processing domain, or the like. Based on detecting a request to execute a cross-domain operation, the cross-domain transfer request handler 420 determines whether to process the transfer request on a “fast” execution path (e.g., in the blockchain context, a path in which minting of tokens on the second blockchain is not premised on completion of a corresponding burn operation on the first blockchain), or on a “slow” execution path (e.g., in the blockchain context, a path in which minting of tokens on the second blockchain is premised on completion of a corresponding burn operation on the first blockchain). In some aspects, the cross-chain transfer request handler 420 can determine whether to process the request to perform a cross-domain operation using the “fast” execution path based on the presence of a reserved value for a parameter in the request, based on an allowlist of users that are permitted to perform a cross-domain operation (e.g., in the blockchain context, bridge tokens from a first blockchain to a second blockchain), a comparison of a quantity of digital assets involved in the cross-domain operation (e.g., tokens to be transferred between blockchains) to an allowance from a cross-domain reserve resource pool, or the like. If the cross-domain transfer request handler 420 determines that the request can be processed using the “fast” path, the cross-domain transfer request handler 420 can listen for block confirmations associated with a first operation on the source processing domain and initiate a corresponding second operation on the target processing domain when a sufficient number of block confirmations have been detected.

The action executor 430 generally corresponds to the action executor 114 illustrated in FIG. 1. Generally, the action executor 430 uses resources from a cross-domain reserve resource pool to execute an operation on the target blockchain in satisfaction of a request to perform a cross-domain operation broadcast on the source processing domain. To allow for processing of the cross-domain operation request on the “fast” execution path, the action executor 430 may be configured to perform the second operation on the second processing domain prior to receiving confirmation that a corresponding first operation has been finalized and is irreversible on the source processing domain.

### Example Clauses

Implementation details for various aspects of the present disclosure are described in the following numbered clauses.

Clause 1: A processor-implemented method, comprising: receiving a request to execute a cross-domain transaction on a source processing domain and a target processing domain; executing, based on detecting initiation of a first operation on the source processing domain, corresponding second operation on the target processing domain, wherein the second operation is performed using resources in a cross-domain reserve resource pool, and wherein a request associated with the second operation includes a signature generated by an issuer of a digital asset associated with the cross-domain transaction and associated with the first operation on the source processing domain; and finalizing execution of the request based on minting the quantity of tokens on the target processing domain.

Clause 2: The method of Clause 1, wherein the request is finalized without waiting for completion of the first operation on the source processing domain.

Clause 3: The method of any of Clauses 1 or 2, wherein the request comprises a cross-chain transaction request between the source processing domain and the target processing domain including a reserved value for a finality threshold, the reserved value indicating that the request can be finalized without waiting for completion of the first operation on the source processing domain.

Clause 4: The method of any of Clauses 1 through 3, wherein: the request includes an identifier of a sender associated with the request; and the method further includes allowing, based on the identifier of the sender being including on an allowlist, execution of the second operation on the target processing domain based on detecting initiation of the first operation on the source processing domain.

Clause 5: The method of any of Clauses 1 through 4, wherein the first operation comprises a token burn operation and the second operation comprises a minting operation, and wherein the minting is further based on a comparison of a quantity of tokens included in the request and an outstanding allowance for token minting from the cross-domain reserve resource pool.

Clause 6: The method of any of Clauses 1 through 5, wherein execution of the second operation is based on detecting a threshold number of block confirmation messages associated with the first operation on the source processing domain.

Clause 7: The method of Claim 6, further comprising: based on failing to detect the threshold number of block confirmation messages within a threshold time period, initiating execution of the second operation on the target processing domain in response to on detecting completion of the first operation on the source processing domain.

Clause 8: The method of any of Clauses 1 through 7, wherein an amount of resources associated with the cross-domain reserve resource pool is replenished after the request is finalized based on confirmation of the first operation.

Clause 9: The method of any of Clauses 1 through 8, wherein the request further includes information associated with one or more additional actions to execute as part of satisfying the request.

Clause 10: The method of Clause 9, wherein at least the second operation and execution of the one or more additional actions are performed as an atomic operation.

Clause 11: A processor-implemented method, comprising: receiving a request to transfer a quantity of tokens from a source blockchain to a target blockchain; minting, based on detecting initiation of a burn operation for the quantity of tokens on the source blockchain, the quantity of tokens on the target blockchain, wherein the minting is performed using resources in a cross-blockchain reserve resource pool, and wherein a request associated with the minting includes a signature generated by an issuer of the tokens and associated with the burn operation on the source blockchain; and finalizing execution of the request based on minting the quantity of tokens on the target blockchain.

Clause 12: The method of Clause 11, wherein the request is finalized without waiting for completion of the burn operation on the source blockchain.

Clause 13: The method of any of Clauses 11 or 12, wherein the request comprises a cross-chain transaction request between the source blockchain and the target blockchain including a reserved value for a finality threshold, the reserved value indicating that the request can be finalized without waiting for completion of the burn operation on the source blockchain.

Clause 14: The method of any of Clauses 11 through 13, wherein: the request includes an identifier of a sender associated with the request; and the method further includes allowing, based on the identifier of the sender being including on an allowlist, minting of the quantity of tokens on the target blockchain based on detecting initiation of the burn operation.

Clause 15: The method of any of Clauses 11 through 14, wherein the minting is further based on a comparison of the quantity of tokens included in the request and an outstanding allowance for token minting from the cross-blockchain reserve resource pool.

Clause 16: The method of any of Clauses 11 through 15, wherein the minting is based on detecting a threshold number of block confirmation messages associated with the burn operation on the source blockchain.

Clause 17: The method of Clause 16, further comprising: based on failing to detect the threshold number of block confirmation messages within a threshold time period, initiating minting of the quantity of tokens on the target blockchain in response to detecting completion of the burn operation on the source blockchain.

Clause 18: The method of any of Clauses 11 through 17, wherein an amount of resources associated with the cross-blockchain reserve resource pool is replenished after the request is finalized based on confirmation of the burn operation.

Clause 19: The method of any of Clauses 11 through 18, wherein the request further includes information associated with one or more additional actions to execute as part of satisfying the request.

Clause 20: The method of Clause 19, wherein at least the minting and execution of the one or more additional actions are performed as an atomic operation.

Clause 21: A system, comprising: a memory having executable instructions stored thereon; and a processor configured to execute the executable instructions to perform the operations of any one of Clauses 1 through 20.

Clause 22: A system, comprising: means for performing the operations of any one of Clauses 1 through 20.

Clause 23: A computer-readable medium having instructions stored thereon which, when executed by a processor, performs the operations of any one of Clauses 1 through 20.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
receiving a request to execute a cross-domain transaction on a source processing domain and a target processing domain;
executing, based on detecting initiation of a first operation on the source processing domain, a corresponding second operation on the target processing domain, wherein the second operation is performed using resources in a cross-processing domain reserve resource pool, and wherein a request associated with the second operation includes a signature generated by an issuer of a digital asset associated with the cross-domain transaction and associated with the first operation on the source processing domain; and
finalizing execution of the request based on executing the second operation on the target processing domain.

2. The method of claim 1, wherein the request is finalized without waiting for completion of the first operation on the source processing domain.

3. The method of claim 1, wherein the request comprises a cross-chain transaction request between the source processing domain and the target processing domain including a reserved value for a finality threshold, the reserved value indicating that the request can be finalized without waiting for completion of the first operation on the source processing domain.

4. The method of claim 1, wherein:
the request includes an identifier of a sender associated with the request; and
the method further includes allowing, based on the identifier of the sender being including on an allowlist, execution of the second operation on the target processing domain based on detecting initiation of the first operation.

5. The method of claim 1, wherein the first operation comprises a token burn operation and the second operation comprises a minting operation, and wherein the minting operation is further based on a comparison of a quantity of tokens included in the request and an outstanding allowance for token minting from the cross-processing domain reserve resource pool.

6. The method of claim 1, wherein execution of the second operation is based on detecting a threshold number of block confirmation messages associated with the first operation on the source processing domain.

7. The method of claim 6, further comprising:
based on failing to detect the threshold number of block confirmation messages within a threshold time period,
initiating execution of the second operation on the target processing domain in response to detecting completion of the first operation on the source processing domain.

8. The method of claim 1, wherein an amount of resources associated with the cross-processing domain reserve resource pool is replenished after the request is finalized based on confirmation of the first operation on the source processing domain.

9. The method of claim 1, wherein the request further includes information associated with one or more additional actions to execute as part of satisfying the request.

10. The method of claim 9, wherein at least execution of the second operation on the target processing domain and execution of the one or more additional actions are performed as an atomic operation.

11. A processing system, comprising:
at least one memory having executable instructions stored thereon; and
one or more processors configured to execute the executable instructions in order to cause the processing system to:
receive a request to execute a cross-domain transaction on a source processing domain and a target processing domain;
execute, based on detecting initiation of a first operation on the source processing domain, a corresponding second operation on the target processing domain, wherein the second operation is performed using resources in a cross-processing domain reserve resource pool, and wherein a request associated with the second operation includes a signature generated by an issuer of a digital asset associated with the cross-domain transaction and associated with the first operation on the source processing domain; and
finalize execution of the request based on executing the second operation on the target processing domain.

12. The processing system of claim 11, wherein the request is finalized without waiting for completion of the first operation on the source processing domain.

13. The processing system of claim 11, wherein the request comprises a cross-chain transaction request between the source processing domain and the target processing domain including a reserved value for a finality threshold, the reserved value indicating that the request can be finalized without waiting for completion of the first operation on the source processing domain.

14. The processing system of claim 11, wherein:
the request includes an identifier of a sender associated with the request; and
the one or more processors are further configured to cause the processing system to allow, based on the identifier of the sender being including on an allowlist, execution of the second operation on the target processing domain based on detecting initiation of the first operation.

15. The processing system of claim 11, wherein the first operation comprises a token burn operation and the second operation comprises a minting operation, and wherein the minting operation is further based on a comparison of a quantity of tokens included in the request and an outstanding allowance for token minting from the cross-processing domain reserve resource pool.

16. The processing system of claim 11, wherein execution of the second operation is based on detecting a threshold number of block confirmation messages associated with the first operation on the source processing domain.

17. The processing system of claim 16, wherein the one or more processors are configured to cause the processing system to:
initiate, based on failing to detect the threshold number of block confirmation messages within a threshold time period, execution of the second operation on the target processing domain in response to detecting completion of the first operation on the source processing domain.

18. The processing system of claim 11, wherein an amount of resources associated with the cross-processing domain reserve resource pool is replenished after the request is finalized based on confirmation of the first operation on the source processing domain.

19. The processing system of claim 11, wherein the request further includes information associated with one or more additional actions to execute as part of satisfying the request.

20. The processing system of claim 19, wherein at least execution of the second operation on the target processing domain and execution of the one or more additional actions are performed as an atomic operation.

21. A processor-implemented method, comprising:
receiving a request to transfer a quantity of tokens from a source blockchain to a target blockchain;
minting, based on detecting initiation of a burn operation for the quantity of tokens on the source blockchain, the quantity of tokens on the target blockchain, wherein the minting is performed using resources in a cross-blockchain reserve resource pool, and wherein a request associated with the minting includes a signature generated by an issuer of the tokens and associated with the burn operation on the source blockchain; and
finalizing execution of the request based on minting the quantity of tokens on the target blockchain.

22. The method of claim 21, wherein the request is finalized without waiting for completion of the burn operation on the source blockchain.

23. The method of claim 21, wherein the request comprises a cross-chain transaction request between the source blockchain and the target blockchain including a reserved value for a finality threshold, the reserved value indicating that the request can be finalized without waiting for completion of the burn operation on the source blockchain.

24. The method of claim 21, wherein:
the request includes an identifier of a sender associated with the request; and
the method further includes allowing, based on the identifier of the sender being including on an allowlist, minting of the quantity of tokens on the target blockchain based on detecting initiation of the burn operation.

25. The method of claim 21, wherein the minting is further based on a comparison of the quantity of tokens included in the request and an outstanding allowance for token minting from the cross-blockchain reserve resource pool.

26. The method of claim 21, wherein the minting is based on detecting a threshold number of block confirmation messages associated with the burn operation on the source blockchain.

27. The method of claim 26, further comprising:
based on failing to detect the threshold number of block confirmation messages within a threshold time period,
initiating minting of the quantity of tokens on the target blockchain in response to detecting completion of the burn operation on the source blockchain.

28. The method of claim 21, wherein an amount of resources associated with the cross-blockchain reserve resource pool is replenished after the request is finalized based on confirmation of the burn operation.

29. The method of claim 21, wherein the request further includes information associated with one or more additional actions to execute as part of satisfying the request.

30. The method of claim 29, wherein at least the minting and execution of the one or more additional actions are performed as an atomic operation.
